(19) United States
(12) Patent Application Publication
(10) Pub. No.: US 2013/0085806 A1
(43) Pub. Date: Apr. 4, 2013

(54) METHOD FOR PREFERENCE DETERMINATION

(71) Applicant: Peter Rothschild, New Haven, VT (US)

(72) Inventor: Peter Rothschild, New Haven, VT (US)

(21) Appl. No.: 13/248,358

(22) Filed: Sep. 29, 2011

(51) Int. Cl. G06Q 10/00

(52) U.S. Cl. 705/7.32

(57) ABSTRACT

A methodology is disclosed that can be used in online surveys, or to an audience gathered in a physical location, in which they can see the images of products shown on a computer monitor, a projection screen or hand-held device, or see and feel the actual products. In an exemplary embodiment, the method includes the steps of: pre-screening said assortment by a respondent to produce a pre-screened assortment; performing a max-diff exercise for the pre-screened assortment to create a set of ranked results; creating an intermediate sub-assortment (ISA) based on ranked results of the max-diff exercise; performing either a chip allocation or choice rank exercise on the ISA based on results of the max-diff exercise; and combining results of the chip allocation or choice rank exercise with results by additional respondents.

### FIELD OF INVENTION

This invention relates to field of consumer preference survey methods.

### BACKGROUND OF THE INVENTION

Retailers and brand manufacturers have long sought a way to accurately forecast the sales of merchandise that will be placed for sale in stores. The nature of the apparel, footwear, and accessories business is such that the offerings in these sectors of the fashion business change from season to season and from year to year. Since many items are new to consumers from the moment they arrive in stores (unlike most offerings in a supermarket that are the same from month to month), there is a high risk of having consumers not accepting them.

Forecasts for the salability of items to be put into stores depends in large part on the aggregation of personal preferences expressed by consumers. The quest for determining quantitative forecasts of consumer preference for new items has proven difficult due to the vast amount of items from which to choose and the difficulty of showing these items to consumers well prior to the decisions to buy merchandise to be placed in inventory.

It has been proven over the years by numerous market researchers that it is very difficult for consumers to rank-order their preferences across a large number of items, and this difficulty increases dramatically as the number of items in an assortment increases. Assortments much larger than ten items present a very difficult challenge for a person to put into rank order according to his/her personal preference. Typically, there are new assortments of 50 to over 100 items for which preference forecasts are desired. Ergo, it is virtually impossible for an individual to place these items in the rank-order that he/she would likely purchase them.

Additionally, consumers do not purchase items of apparel, footwear, or accessories based solely on the rank-order of their preferences for these items. The purchase behavior of consumers is non-linear compared with the rank-order of their stated purchase likelihoods. This is because their stated first, second, third, to “n” choices may be for similar kinds of items. Once one of these choices is purchased by a consumer, he/she looks for items beyond this “first group” for the next item to buy.

Various methodologies currently exist, as will be described below.

Maximum Difference

Maximum Difference (Max-Diff) is a well-known methodology for determining rank-order and strength of preference by asking survey respondents to evaluate sets of three or four items in which they indicate the one they like the best and the one they like the least. The combinations of items appearing in these sets is iterated many times, so that each item is seen two or three times in different combinations by all the respondents to a survey. The output of Max-Diff exercises are utility scores for each item in the exercise as well as a distribution of apparent first, second, third . . . to n choices. This methodology fails to produce accurate data when compared with actual sales of products in a retail environment. It has been found that Max-Diff is not very reliable at predicting survey respondents' first choices, and it fails completely to predict second and third choices. This is because a respondent often buys more than one item at a time, and his/her second and third choices are conditioned by the first choice. The methodology simply cannot determine the conditional choices. Moreover, respondents taking a survey have been proven to be unwilling or unable to evaluate much more than sixty to seventy items, because of the amount of time it takes to observe all combinations of the items, limits of human concentration and survey respondent fatigue. U.S. Pat. No. 6,338,051, issued to Kang on Jan. 8, 2002, discusses max-diff exercises. All references cited herein are incorporated by reference.

Conjoint Exercises

Conjoint exercises involve surveys wherein respondents choose among three or four items based on different attributes of the items. Sawtooth Software is one provider of conjoint survey products. While in some ways these conjoint approaches are more sophisticated than Max-Diff, they still suffer from precisely the same issues confronting Max-Diff; the inability to determine conditional preference, and the limit to the number of items a respondent can evaluate in a survey. U.S. Pat. No. 6,826,541, issued to Johnston on Nov. 30, 2004 discloses conjoint exercises.

Chip Allocation

In Chip allocation, survey respondents are given a specified amount of “money,” represented by “chips,” to spend on items shown in an assortment. The idea is that this methodology will approximate a consumer's behavior in a retail environment in which conditional (interdependent) choices are reflected. The shortcoming with this approach is that survey respondents are incapable of making “narrow decisions” (deciding between three or four items) from wide assortments (consisting of more than twenty items). Because of the uncertainties and confusion inherent in making a few chip-allocation choices from among a large number of items, the distribution of the forecasted purchases of the items shown in a typical Chip Allocation does not compare well with real-world realities in retail stores. Conversely, using Chip Allocation for determining consumer choices from an assortment with a small number of items fails, because the number of items shown does not represent the breadth of assortments found in stores. U.S. Pat. No. 7,769,626, issued to Reynolds on Aug. 3, 2010, and US Published Patent Application 2008/0065471 A1, published Mar. 13, 2008 discuss Chip Allocation.

Buying Simulation

Buying Simulation presents survey respondents with an interface that looks similar to an online retail store. The respondent is asked what he/she would likely purchase, with or without limitations on the number of items to be “purchased” or the amount of money to be” “spent.” This approach suffers from the same limitations noted for Chip Allocation.

Choice Ranking

Choice Ranking is a very straight-forward approach that presents a survey respondent with a number of items (the same number as would be shown using Chip Allocation or Buying Simulation) and simply asking them which item, if any, they would buy first, and which item they would buy next, and so on through two to three choices. Choice ranking, or in other words, “forced-choices”, is extremely difficult for an individual to accomplish because, as noted above, it is very difficult for consumers to rank-order their preferences across a large number of items, and this difficulty increases dramatically as the number of items in an assortment increases. Assortments much larger than ten items present a very difficult challenge for a person to put into rank order according to his/her personal preference. Forced-Choice is quite similar to Chip Allocation except that rather than having decisions bound by the number of Chips to “spend”, an individual's choices are bound by the number of items they are allowed to “purchase” in the exercise.

In addition to the references listed above, the following patents and publications are relevant to the field of consumer preference determination: U.S. Pat. Nos. 5,124,911; 7,191,144; 7,308,418; 7,610,249; and 7,904,331 and US Published Application nos. 2009/0327163 A1 and 2006/0041401 A1.

### SUMMARY OF THE INVENTION

A methodology is disclosed that can be used in online surveys, or to an audience gathered in a physical location, in which they can see the images of products shown on a computer monitor, a projection screen or hand-held device, or see and feel the actual products.

In an exemplary embodiment, the method includes the steps of: pre-screening said assortment by a respondent to produce a pre-screened assortment; performing a max-diff exercise on the pre-screened assortment to create a set of ranked results; creating an intermediate sub-assortment (ISA) based on ranked results of the max-diff exercise; performing either a chip allocation or choice rank exercise on the ISA based on results of the max-diff exercise; and combining results of the chip allocation or choice rank exercise with results by additional respondents.

In a further embodiment, the ISA consists of no less than seven and no more than twenty items. In a further embodiment, the ISA comprises at least four of the most highly-ranked items of said ranked results. In a further embodiment, the assortment is classified into groups and the ISA is formed to have between one and three of the most highly-ranked items from each of said groups. In a further embodiment, the pre-screening comprises rejecting items that the respondent would not purchase and the rejected items are excluded from the pre-screened assortment. In a further embodiment, the ISA only contains items from the pre-screened assortment. In a further embodiment, a chip allocation exercise is performed when it is likely that the respondent would buy more than one item from the pre-screened assortment, and a choice exercise is performed when it is unlikely that the respondent would buy more than one item from the pre-screened assortment.

In a further embodiment, the assortment of products is presented to the respondents in an online survey. In a further embodiment, the assortment of products is presented to the respondents as a display of images of the products to a group audience gathered in a single location. In a further embodiment, the assortment of products is physically presented to the respondent in an individual single or group setting that respondents can see and feel the products.

In further embodiment, the invention comprises a method for evaluating consumer preference for a first assortment of products of a first kind together with a second assortment of products of a second kind. The method includes the steps of: pre-screening the first and second assortments to produce a first and second pre-screened assortments; performing a first max-diff exercises on the first and second pre-screened assortment to create a first and second sets of set of ranked results; creating first and second intermediate sub-assortments (ISA) based on the first and second sets of ranked results; performing either a chip allocations or choice rank exercises on the first and second ISAs based on the results of the first and second max-diff exercises; combining results of the first chip allocation or choice rank exercise with results of said second chip allocation or second choice rank exercise by additional respondents to create a third ISA; performing either a third chip allocation or third choice rank exercise on the third ISA based on the first and second results of the first and second max-diff exercises; and combining results of the third chip allocation or third choice rank exercise with results by additional respondents.

In a further embodiment, the invention comprise a system for presenting products to respondents to evaluate consumer preference for an assortment of products of given kind. The system has a computer having a database for storing information about the products. The computer is arranged to present the products to the respondents and to allow the respondents to perform the following steps: to pre-screen the assortment to produce and store a pre-screened assortment; to perform a max-diff exercise for said pre-screened assortment to create and store a set of ranked results. The computer also creates and stores an intermediate sub-assortment (ISA) based on ranked results of the max-diff exercise and then the computer presents to the respondent either a chip allocation exercise or a choice rank exercise on the ISA based on the results of the max-diff exercise and then stores the result of the respondent's performance of the chip allocation exercise or choice rank exercise, and the combines results of the chip allocation or choice rank exercise with results by additional respondents.

In a further embodiment of the system, the ISA consists of no less than seven and no more than twenty items. In a further embodiment, the ISA comprises at least four of the most highly-ranked items of said ranked results. In a further embodiment, the assortment is classified into groups and the ISA is formed to have between one and three of the most highly-ranked items from each of said groups. In a further embodiment, the pre-screening comprises rejecting items that the respondent would not purchase and the rejected items are excluded from the pre-screened assortment. In a further embodiment, the ISA only contains items from the pre-screened assortment. In a further embodiment, a chip allocation exercise is performed when it is likely that the respondent would buy more than one item from the pre-screened assortment, and a choice exercise is performed when it is unlikely that the respondent would buy more than one item from the pre-screened assortment.

### BRIEF DESCRIPTION OF SEVERAL VIEWS OF THE DRAWINGS

The invention will be described in conjunction with the following drawings in which like reference numerals designate like elements and wherein:

FIG. 1 is a flow diagram of an exemplary preference survey process;

FIG. 2 is a flow diagram of an enhanced version of the process of FIG. 1; and

FIG. 3 is a flow diagram of an exemplary preference survey process for multiple assortments of items to be surveyed.

### DETAILED DESCRIPTION OF THE INVENTION

The disclosed methodology is one of successive distillations of product survey assortments using a variety of existing research methodologies in combination with novel methods and rules. The distillation process results in surveys in which each respondent spends most of his or her time evaluating assortments that at each successive level focus more upon items in which the respondent has a higher degree of interest.

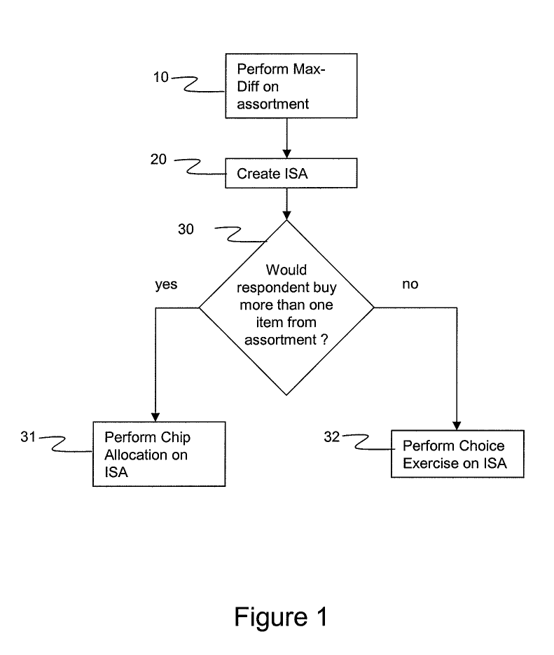

In an exemplary embodiment, and with reference to FIG. 1, the survey process starts at Step 10 with Max-Diff exercise(s) to determine the rank-order of the distribution of choices for the items in an assortment.

Next, at step 20, for each survey respondent, an Intermediate Sub-Assortment (ISA) of seven to twenty items is created. The ISA is approximately one quarter to one third of the size of the initial assortment evaluated in the Max-Diff(s) associated with the ISA. The items in the ISA reflect each individual's preferences taking into account his/her highest ranked choices from the Max-Diff exercise along with alternate choices based on rules that reflect items not highly ranked by the Max-Diff, but ones that are quite likely to be purchased after the respondent's first and/or second, and/or third choices.

For assortments from which a respondent is expected to purchase more than one item, at step 31, each respondent is shown an ISA as described above wherein the respondent performs a Chip Allocation to decided what he or she would purchase given a specified amount of “money.” The distribution of choices in these Chip Allocations produces data that correlates very well with empirical data from retail stores and creates a valuable forecast of the likely sales of items within the initial large assortment.

For assortments from which a respondent is unlikely to purchase more than one item, at step 32, each respondent is shown an ISA as described above, wherein the respondent is asked to indicate which item he or she is most likely to buy (if any). Then the respondent is asked which of the items in the ISA would be acceptable as a substitute for his or her first choice if that choice is not available.

Max-Diff Advancements

Due to survey respondent fatigue, there are limitations to the number of items in a Max-Diff exercise that can be accurately evaluated in a survey: It has been determined from analyses of survey drop-out rates and response variances, that the maximum number of items that a respondent can evaluate in Max-Diff exercise(s) in a single survey range from 60-80 items (the range of items is due to differences in the types of items being evaluated). Evaluating more than 60-80 items in Max-Diff exercise(s) engenders respondent fatigue, irritation, drops-outs, and/or inaccurate responses.

Since the purpose of the Max-Diff exercise(s) is to determine the rank-order of items that a respondent is likely to purchase from an assortment, those items that a respondent has no (or very low) intention of buying can be eliminated from a Max-Diff exercise. By Pre-Screening these items a “unique” Max-Diff exercise is created for each respondent. The benefit of this approach is that the elimination of items from Max-Diff exercise(s) for which a respondent has little or no desire to purchase, allows each respondent to focus on items for which there is a greater degree of interest, and therefore generates greater discrimination between these items than would be the case if “low intention” items were included in the exercise. This also allows assortments of larger initial sizes (80-160 items) to be evaluated by a single respondent, who now is not wasting time in a Max-Diff exercise evaluating items for which there is little or no desire to purchase. The inventor has found, through experimentation and testing, that pre-screening of items that will be used in a Max-Diff exercise to boil down the number of choices to a more manageable number improves the discrimination between the items likely to be purchased.

With the elimination of items prior to a Max-Diff exercise, each respondent may have a different collection of items in the Max-Diff exercise. This complicates the calculation of Max-Diff Utility Scores. Since the inventor has determined from comparisons of Max-Diff Utility scores with empirical retail data that the Max-Diff Utilities can be quite inaccurate, the Max-Diff scores are not used in the final preference calculations. Rather, in an exemplary embodiment of the invention, the rank-order of item preference from each respondent's Max-Diff exercise is used as the basis for creating an ISA.

As a practical matter, the Max-Diff exercises for each respondent should contain the exact same number of items (even though the items in each respondent's Max-Diff may be different). The reason for this is that it is much more difficult to conduct and tabulate a survey with different set sizes for the different respondents. In an embodiment, this is accomplished by instructing a respondent to select (i.e., reject) a specific number of items in an assortment that he or she is very unlikely to wear or buy.

In an exemplary embodiment, a pre-screening exercise is stated as follows: “Below are 40 cotton polo shirts for next Summer. Please show us the ones you are least excited about by marking 20 of these that you are least likely to wear, by checking ‘Not for Me.’ We will keep a count of how many you need to check.” Wherein, the respondent is presented with a computer screen showing the polo shirt varieties with “not for me” check boxes located near each shirt.

### Using Max-Diff Exercise(s) as a Front-End for Chip Allocation-Buying Simulation, or Choice Exercises

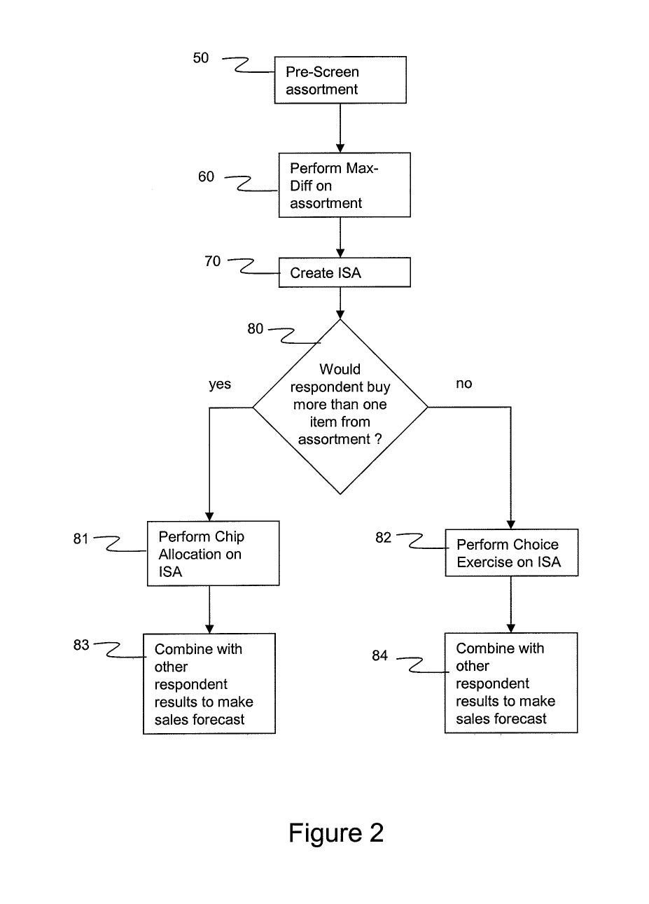

As shown in FIG. 2, step 60 a Max-Diff Exercise(s) is performed after the pre-screening process (step 50) as the way to reduce the size of an assortment of up to 80 items down to 7-20 items that can be evaluated by respondents via Chip Allocation-Buying Simulation or Choice Exercises. The objective is to ultimately have respondents evaluate an Intermediate Sub-Assortment (ISA) of 7-20 items in either a Chip Allocation-Buying Simulation or Choice Exercise that represent the items from the initial assortment that a survey respondent is most likely to purchase.

The Max-Diff exercise creates each survey respondent's approximate rank-order of preference, but simply putting into Chip Allocation or Buying Simulation an ISA containing the top ranking 7-20 items from a Max-Diff exercise(s) will produce inaccurate forecast data coming out of the Chip Allocation-Buying Simulation or Choice Exercises because those 7-20 items will omit certain items that the respondent will likely buy. Hence, the inventor has developed a set of rules to create from the Max-Diff preference data an ISA that will contain all the items most likely to be purchased by a respondent.

### Creating the Intermediate Sub-Assortments (ISA)

These rules join the output of a Max-Diff exercise(s) to a Chip Allocation-Buying Simulation or Choice Ranking Exercise, which then produces an output that correlates to a much higher degree with actual retail sales of the surveyed items than would the output of the Chip Allocation-Buying Simulation or Choice Ranking exercise where the inputs were simply the most preferred items in the Max-Diff exercise (measured by Max-Diff Utility scores or raw ranking of preference choices in the Max-Diff exercise). The rules-based ISA creates a synergy, because the value of the data created by the joining of Max-Diff to Chip Allocation-Buying Simulation or Choice Ranking is of much greater accuracy (hence value) than would be the data from either Max-Diff or Chip Allocation-Buying Simulation or Choice Ranking by themselves, or joined without the rules for creating the ISA.

The rules suggest that the ideal size of the ISA should be no less than seven and not larger than twenty items. The minimum of seven items ensures that the ISA will be large enough to offer the respondent a variety of highly rated items to “buy” in a Chip Allocation-Buying Simulation or to choose from in a Choice Exercise. The maximum of twenty items ensures that the ISA does not grown to such a large size as to cause the survey respondent to be confused or to lose focus.

The rules first require the initial assortment to be classified into groups. The initial assortment is the entire universe of items to be evaluated in the Max-Diff Pre-Screen; thus the initial assortment is the INPUT to the Max-Diff Pre-Screen. Items may be grouped by families of color, types of patterns (plaids, stripes, prints, etc.), types of fabric and construction, etc.

The rules further require the ISA to contain the four or five most highly ranked items from a survey respondent's Max-Diff, plus the one to three most highly ranked items in each group not being represented in the four to five most highly ranked items overall. No items contained in the ISA may have been rejected by the respondent during the Pre-Max-Diff screening. The first four or five most highly ranked items may come from one group or multiple groups. For example, suppose an a product assortment having four groups and that the highest ranked five items are three from Group A and two from Group B, and none from Group C or Group D. To create the ISA, one would take the initial five items and add two items from Group C and 2 items from Group D, thereby putting 9 items into the purchase simulation that crosses over the four groups.

In a further example, suppose a product assortment having three groups, A, B and C. Three items from Group A and two from Group B were the highest ranking overall items. TO round out the ISA, an additional item from Group B (the highest ranking item from the group not counting the first two already selected and three from Group C (the three highest-ranking in Group C) would result in an ISA of nine items, with three from each group.

In a further embodiment, an ISA created from the outputs of multiple Buying-Simulation or Choice Exercises taken by a single respondent can be also used as the basis for a follow-on Chip Allocation-Buying Simulation that evaluates items across classifications of merchandise producing a distribution of preferences for each classification. Each multiple Buying-Simulation or Choice Exercise is based on the ISA created for a specific exercise. The outputs of the simulation exercises are aggregated into another ISA, and this ISA is used as the input for another Buying-Simulation. The benefit of this approach is that allows the comparison of preferences across multiple Max-Diff preference exercises, which is not possible otherwise. Thus, each Max-Diff exercise produces a preference curve that reflects the relative preference of each item to another within the exercise. In the prior art, Max-Diff preference scores (utilities) from one exercise cannot be compared to the preference scores with any other Max-Diff exercise.

Chip Allocation-Buying Simulation

Following the creation of an ISA (step 70), the respondent is given a Chip Allocation-Buying Simulation 81 when it is likely that that respondent would buy more than one item from the initial Max-Diff assortment, as shown at decision point 80. The respondent is shown his or her ISA and given an amount of money to spend, which constrains purchases based on economic choices. The respondent is not required to buy anything and may “save” the “money” for something else, which is also a possible result in a store. The distribution of “purchases” of each item in the Chip Allocation-Buying Simulation becomes the basis for a forecast of sales for each item in the initial assortment 83.

Choice Exercises

Following the creation of an ISA, the respondent is given a Choice Exercise 82 when it is unlikely that a respondent would buy more than one item from the initial Max-Diff assortment. The respondent is shown his or her ISA and asked to indicated the item that he or she would most likely purchase. Note that “none” is an acceptable answer. Then the respondent is shown the item he or she just selected (if any), along with a number of other items that he or she indicated interest in. The respondent is then asked to indicated which of these items (if any) he or she would buy as a substitute for the first choice, should the first choice not be available in a store. The distribution of “purchases” of each item in the Choice Exercise becomes the basis for a forecast of sales for each item in the initial assortment 84.

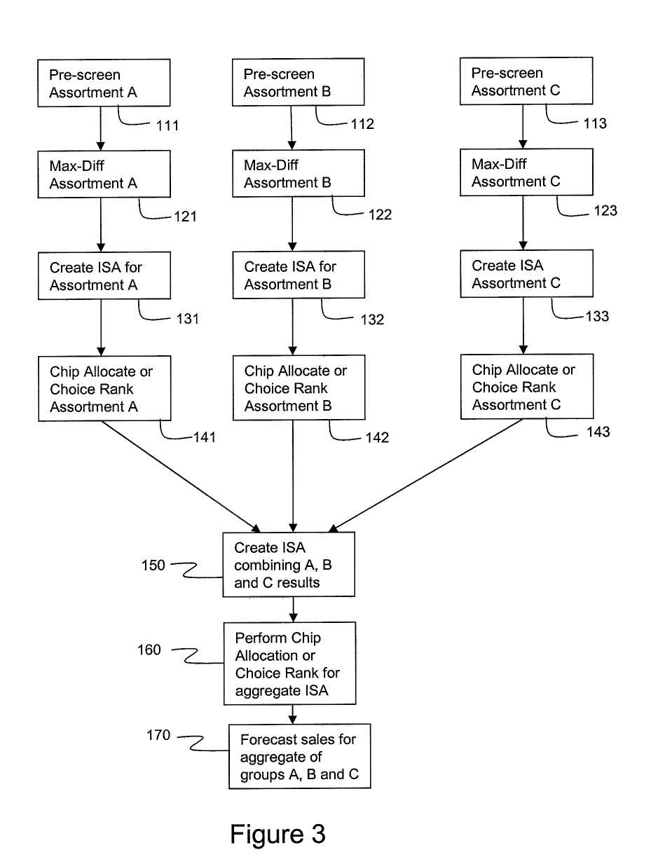

In a further embodiment, the concept of ISA and use of Chip Allocation or Choice Rank exercises based on outcome of the Max-Diff exercise is performed for a plurality of assortments and the results are aggregated into a further ISA for a final round of Chip Allocation or Choice Ranking across the assortment collection. This method is shown in FIG. 3. Pre-screens are performed for Assortments A, B and C with each respondent. 111, 112, and 113. Separate Max-Diff exercises are performed for each pre-screened assortment. 121, 122 and 123. ISAs are created as described herein for each assortment. 131, 132 and 133. Chip Allocation or Choice Ranking is performed for each ISA as required by the respondent's responses in each Max-Diff exercise. 141, 142 and 143. An ISA is then created for the combined results of steps 141. 142 and 142 at step 150. Next, either a Chip Allocation or Choice Ranking is performed on the aggregate ISA at step 160, again based on whether the respondent indicated that he or she would purchase more than one of the items in the ISA. The results of step 160 are combined with those for other respondents to forecast sales for the aggregate of groups A, B and C.

This process across aggregations of assortments produces results much closer to real-life consumer decision-making since it is rare that a consumer is only shopping for or receptive to purchasing a single kind of item at any one time when presented with choices for multiple types of items.

While the invention has been described in detail and with reference to specific examples thereof, it will be apparent to one skilled in the art that various changes and modifications can be made therein without departing from the spirit and scope thereof.

What is claimed is:

1. A method for evaluating consumer preference for an assortment of products of a given kind, comprising:
pre-screening said assortment by a respondent to produce a pre-screened assortment;
performing a max-diff exercise by said respondent for said pre-screened assortment to create a set of ranked results;
creating an intermediate sub-assortment (ISA) based on ranked results of said max-diff exercise;
performing either a chip allocation or choice rank exercise on said ISA by said respondent based on results of said max-diff exercise;
combining results of said chip allocation or choice rank exercise with results by additional respondents.

2. The method of claim 1, wherein said ISA consists of no less than seven and no more than twenty items.

3. The method of claim 1, wherein said ISA comprises at least four of the most highly-ranked items of said ranked results.

4. The method of claim 3, wherein said wherein said assortment is classified into groups and wherein said ISA further comprises between one and three of the most highly-ranked items from each of said groups.

5. The method of claim 1, wherein said pre-screening comprises rejecting items that said respondent would not purchase and wherein said rejected items are excluded from said pre-screened assortment.

6. The method of claim 1, wherein said ISA only contains items from said pre-screened assortment.

7. The method of claim 1, wherein said chip allocation exercise is performed when it is likely that said respondent would buy more than one item from said pre-screened assortment, and said choice exercise is performed when it is unlikely that said respondent would buy more than one item from said pre-screened assortment.

8. A method for evaluating consumer preference for a first assortment of products of a first kind together with a second assortment of products of a second kind comprising:
pre-screening the first assortment by a respondent to produce a first pre-screened assortment;
pre-screening the second assortment by said respondent to produce a second pre-screened assortment
performing a first max-diff exercise by said respondent for said first pre-screened assortment to create a first set of ranked results;
performing a second max-diff exercise by said respondent for said second pre-screened assortment to create a second set of ranked results
creating a first intermediate sub-assortment (ISA) based on said first set of ranked results;
creating a second ISA based on said second set of ranked results;
performing either a first chip allocation or first choice rank exercise on said first ISA by said respondent based on said first results of said first max-diff exercise;
performing either a second chip allocation or second choice rank exercise on said second ISA by said respondent based on said second results of said second max-diff exercise;
combining results of said first chip allocation or first choice rank exercise with results of said second chip allocation or second choice rank exercise to create a third ISA;
performing either a third chip allocation or third choice rank exercise on said third ISA based on said first and second results of said first and second max-diff exercises; and
combining results of said third chip allocation or third choice rank exercise with results by additional respondents.

9. The method of claim 1, wherein said assortment of products is presented to said respondent by means consisting of one or more of: an online survey, a display of images of the products to a group audience gathered in a single location, and presentation of the actual products to the respondents in a single or group setting wherein said respondents can see and feel the products.

10. A system for presenting products to respondents to evaluate consumer preference for an assortment of products of given kind, comprising:
a computer having a database for storing information about said products, said computer arranged to present the products to the respondents and to allow the respondents to perform the following steps:
pre-screen said assortment to produce and store a pre-screened assortment;
perform a max-diff exercise for said pre-screened assortment to create and store a set of ranked results;
said computer being further arranged to create and store an intermediate sub-assortment (ISA) based on ranked results of said max-diff exercise;
said computer being further arranged to present to the respondent either a chip allocation exercise or a choice rank exercise on said ISA based on said stored results of said max-diff exercise and to store the result of the respondent's performance of said chip allocation exercise or choice rank exercise; and
said computer being further arranged to combine results of said chip allocation or choice rank exercise with results by additional respondents.

11. The system of claim 10, wherein said ISA consists of no less than seven and no more than twenty items.

12. The method of claim 10, wherein said ISA comprises at least four of the most highly-ranked items of said ranked results.

13. The method of claim 10, wherein said wherein said assortment is classified into groups and wherein said ISA further comprises between one and three of the most highly-ranked items from each of said groups.

14. The system of claim 10, wherein said pre-screening comprises rejecting items that said respondent would not purchase and wherein said rejected items are excluded from said pre-screened assortment.

15. The method of claim 10, wherein said ISA only contains items from said pre-screened assortment.

16. The method of claim 10, wherein said chip allocation exercise is performed when it is likely that said respondent would buy more than one item from said pre-screened assortment, and said choice exercise is performed when it is unlikely that said respondent would buy more than one item from said pre-screened assortment.
